(19) United States
(12) Patent Application Publication
(10) Pub. No.: US 2003/0171704 A1
(43) Pub. Date: Sep. 11, 2003

(54) Mouth washing device

(76) Inventor: John Duncan McNair, Hong Kong (HK)

Correspondence Address: Gordon & Jacobson, P.C., 65 Woods End Road, Stamford, CT, 06905, US

(21) Appl. No.: 10/093,997

(22) Filed: Mar. 8, 2002

(51) Int. Cl. A61H 9/00; A61H 13/00; A61C 17/00

(52) U.S. Cl. 601/163

(57) ABSTRACT

A mouth washing device includes a handle housing a motor and a driveshaft driven by the motor. A head has a wall having an inner surface defining an internal cavity and an outer surface forming part of the device's exterior, the wall has a number of inlet ports and a number of outlet ports, extending directly between the inner and outer surfaces of the wall. An impeller is located in the cavity and is driven by the driveshaft and adapted upon turning by the motor and driveshaft to draw liquid from a user's mouth into the cavity via the inlet ports and expel the liquid via the outlet ports so as to clean the user's mouth in use.

### BACKGROUND OF THE INVENTION

The present invention relates to mouth washing devices. More particularly, though not exclusively, the invention relates to a hand-held, motor-driven mouth washing device that draws mouth washing liquid in from a user's mouth and expels the liquid, under pressure for rinsing and/or cleaning the inside of the user's mouth.

Hand-held electric toothbrushes have been known for some time. These are used to clean and/or polish teeth. Liquid mouth rinses have also been known for some time. A user of such rinses swishes the liquid inside his or her mouth and then expels the liquid. Often, these liquids are not very effective in removing bacteria or other contaminants from the roof of the mouth, gums and tongue. This is because there is insufficient pressure applied under a mere swishing action.

Various mouth washing devices have been proposed, such as for example the one disclosed in U.S. Pat. No. 6,245,032 (Sauer et al.). This device however suffers from the problem that it draws in a mouth washing liquid from a supply and continuously discharges that liquid during use. In order to be used effectively, a substantial amount of liquid (whether it be water or a special mouth-rinse) must be used. That is, a continuous stream of the liquid is discharged into the user's mouth and the user must expel that liquid continuously. Otherwise, the user's mouth will fill to capacity with liquid, possibly causing the user to gag.

### OBJECTS OF THE INVENTION

It is an object of the present invention to overcome or substantially ameliorate the above disadvantage and/or more generally to provide an improved mouth washing device.

### DISCLOSURE OF THE INVENTION

There is disclosed herein a mouth washing device comprising:

a handle housing a motor and a driveshaft driven by the motor,

a head comprising a wall having an inner surface defining an internal cavity and an outer surface forming part of the device's exterior, the wall having an inlet port and an outlet port, both extending directly between the inner and outer surfaces of the wall,

an impeller located in the cavity and driven by the driveshaft and adapted upon turning by the motor and driveshaft to draw liquid into the cavity via the inlet port and expel the liquid via the outlet port.

Preferably the wall comprises a plurality of said inlet and outlet ports.

Preferably said outlet ports are situated radially outwardly of the impeller.

Preferably the inlet ports are located radially inwardly of the outlet ports.

Preferably the inlet ports are located at either side of an equatorial plane of the head.

Preferably the impeller includes a plurality of blades extending radially of a longitudinal axis of the impeller, which axis is co-linear with a longitudinal axis of the driveshaft.

Preferably a neck extends between the handle and the head.

Preferably the driveshaft passes through the neck.

Preferably a seal is located between the driveshaft and the head and/or neck.

Preferably the motor receives electric power from a battery (located in the handle) via a switch.

### BRIEF DESCRIPTION OF THE DRAWINGS

Preferred forms of the present invention will now be described by way of example with reference to the accompanying drawings, wherein:

FIG. 1 is a schematic cross-sectional elevational view of a head and at the neck portion of a mouth washing device,

FIG. 2 is a schematic plan view of an impeller,

FIG. 3 is a schematic cross-sectional elevational view of a mouth washing device, and

FIG. 4 is a schematic cross-sectional elevational view of ahead and other neck portion of another mouth washing device (corresponding with the plan view of FIG. 2).

### DESCRIPTION OF THE PREFERRED EMBODIMENT

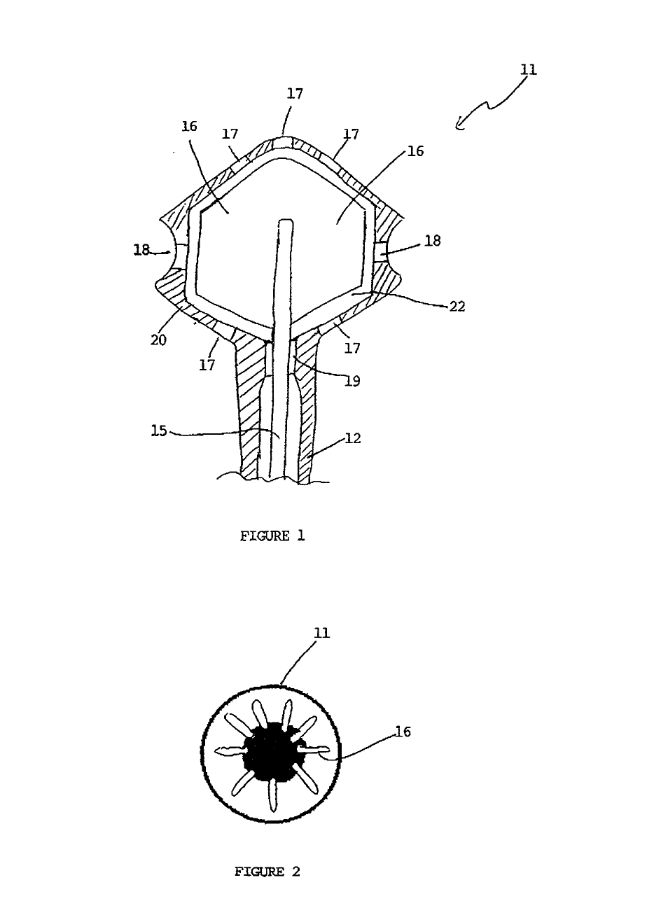

In FIG. 1 of the accompanying drawings there is schematically depicted an upper portion of a mouth washing device including a head 11 typically formed of moulded plastics material. Head 11 comprises a wall 20 defining an internal cavity 22. That is, the internal surface of the wall 20 defines cavity 21, whereas the external surface of the wall 20 forms part of the device's exterior.

The head 11 extends from a neck 12 which in turn extends from a handle 13 within which batteries (typically rechargeable batteries) would be housed. Power from the batteries is delivered via a switch 21 to a motor 14. Motor 14 drives a driveshaft 15 that extends through the neck 12 to the cavity 22. Within the cavity 22 there is located and impeller 16 mounted on the shaft 15 so as to rotate therewith.

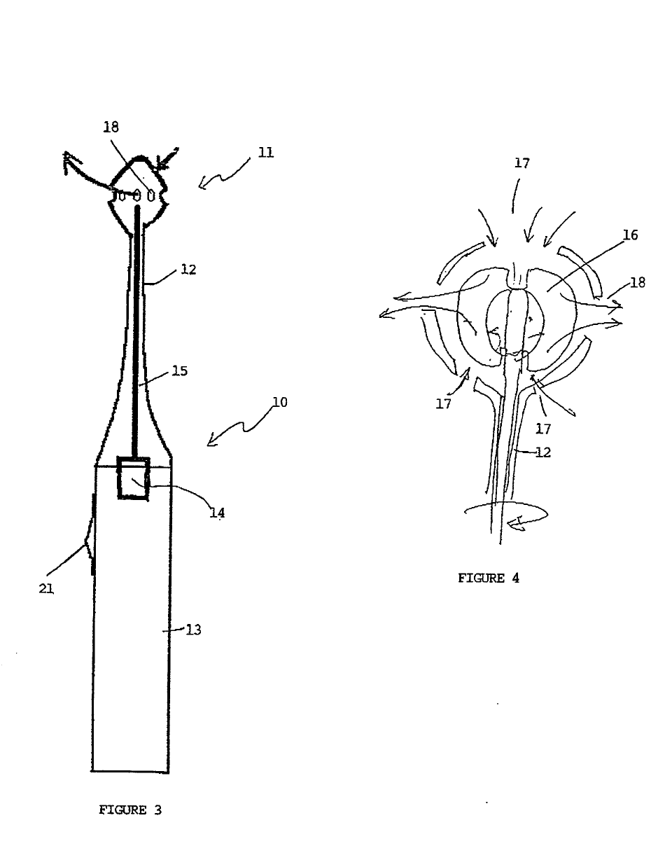

The impeller 16 would typically comprise a number of radially extending blades. There may be two such blades, or three or more blades such as for example as shown in FIG. 2 (corresponding to the embodiment depicted in FIG. 4).

In a circumferential region of the head 11, there is provided a plurality of outlet ports 18. These ports might be considered as being positioned upon an equatorial plane of the head. At one or both sides of this equatorial plane there are provided a number of inlet ports 17. These inlet ports are typically positioned radially inwardly of the outlet ports 18 so as to align with radially inner portions of the blades of the impeller 16.

In use, a user fills or partially fills his or her mouth with liquid mouthwash and then places the head 11 of the device in his or her mouth somewhat as if it were an electric toothbrush. The switch 21 is then depressed or otherwise activated so as to allow current to flow from the battery or batteries to the motor 14. The motor 14 rotates the shaft 15 so as to rotate the impeller 16.

Rotation of impeller 16 within the cavity 22 causes low pressure near the inlet ports 17 to draw the mouth washing liquid from the user's mouth. The impeller blades then throw the liquid under centrifugal force or high pressure through the outlet ports 18 so as to spray the mouth washing liquid against the user's mouth interior including the roof of the mouth, the gums and the tongue etc.

By use of the above-described invention, mouth washing liquid is continuously recycled within the user's mouth so as to be used efficiently. As the mouth is in terms of mouth washing liquid, as closed system during use, there is no need to expell the liquid while the device is running. The user might discard the mouth watching liquid in his or her mouth after a short period and refill his or her mouth with fresh mouth watching liquid and use the device again if required.

It should be appreciated that modifications and alterations obvious to those skilled in the art are not to be considered as beyond the scope of the present invention. For example, the inlet ports might extend beyond the wall 20, or one or more tubes might extend from a corresponding one or more inlet ports to a low point within the user's mouth so as to draw in mouth washing liquid from that low point.

1. A mouth washing device comprising:
a handle housing a motor and a driveshaft driven by the motor,
a head comprising a wall having an inner surface defining an internal cavity and an outer surface forming part of the device's exterior, the wall having an inlet port and an outlet port, both extending directly between the inner and outer surfaces of the wall,
an impeller located in the cavity and driven by the driveshaft and adapted upon turning by the motor and driveshaft to draw liquid into the cavity via the inlet port and expel the liquid via the outlet port.

2. The device of claim 1 wherein the wall comprises a plurality of said inlet and outlet ports.

3. The device of claim 2 wherein said outlet ports are situated radially outwardly of the impeller.

4. The device of claim 2 wherein the inlet ports are located radially inwardly of the outlet ports.

5. The device of claim 2 wherein the inlet ports are located at either side of an equatorial plane of the head.

6. The device of claim 1 wherein the impeller includes a plurality of blades extending radially of a longitudinal axis of the impeller, which axis is co-linear with a longitudinal axis of the driveshaft.

7. The device of claim 1 wherein a neck extends between the handle and the head.

8. The device of claim 7 wherein the driveshaft passes through the neck.

9. The device of claim 8 wherein a seal is located between the driveshaft and the head and/or neck.

10. The device of claim 1 wherein the motor receives electric power from a battery (located in the handle).
